(19) United States
(12) Patent Application Publication
(10) Pub. No.: US 2010/0282680 A1
(43) Pub. Date: Nov. 11, 2010

(54) SUPERHYDROPHOBIC MEMBRANE DISTILLATION FOR WATER PURIFICATION

(75) Inventors: Ming Su, Oviedo, FL (US); Zeyu Ma, Orlando, FL (US)

Correspondence Address: Jetter & Associates, P.A., 8295 North Military Trail, Suite F, Palm Beach Gardens, FL, 33410, US

(73) Assignee: University of Central Florida Research Foundation, Inc., Orlando, FL (US)

(21) Appl. No.: 12/774,970

(22) Filed: May 6, 2010

Related U.S. Application Data
(60) Provisional application No. 61/175,857, filed on May 6, 2009.

(51) Int. Cl. B01D 61/36; C02F 1/04; B01D 69/00; B01D 3/00

(52) U.S. Cl. 210/640; 210/483; 210/500.21; 210/500.26; 210/500.27

(57) ABSTRACT

A distillation membrane for purifying water includes a superhydrophobic surface having a plurality of protruding features that each include a microchannel therein that protrude from a recessed surface portion that is in a uniform thickness portion of the distillation membrane. A thickness of the uniform thickness portion defines a channel length of the distillation membrane. The distillation membrane includes a plurality of micropores that are each fluidicly coupled to respective ones of the microchannels, wherein the plurality of micropores extend through the channel length. The superhydrophobic surface is operable to reject liquid water and the microchannels coupled to the micropores are operable to pass water vapor therethrough to allow condensation of the water vapor on a side of the distillation membrane opposite the superhydrophobic surface.

### CROSS REFERENCE TO RELATED APPLICATIONS

This application and the subject matter disclosed herein claims the benefit of Provisional Application Ser. No. 61/175,857 entitled “SUPERHYDROPHOBIC MEMBRANE DISTILLATION FOR WATER PURIFICATION”, filed May 6, 2009, which is herein incorporated by reference in its entirety.

### FIELD

Embodiments of the invention relate to membrane distillation, particularly for water purification.

### BACKGROUND

Desalination of seawater and other water processing methods are of significant importance in supplying drinking water to the world's population. Of all the surface water on the planet, only approximately 2.5% is fresh water. Of this, approximately 80% is bound as moisture in soil or frozen in the polar icecaps, so only approximately 0.5% of the total surface water is available as drinking water. Furthermore, drinking water supplies are very unevenly distributed. Therefore, a large portion of the planet's population suffers from water shortage.

To overcome this problem, numerous methods have been proposed for desalination of seawater. Some of the requirements to be met are difficult, because seawater has a salt content of approximately 30 g/L, whereas according to the World Health Organization (WHO), the salt content of drinking water must not exceed 0.5 g/L. In conventional distillation methods, water vapor is evaporated from salt water by applying heat to form water vapor and then condensing the water vapor on a cooled surface.

To reduce the cost of the high energy consumption, there have been many attempts to use solar energy as the energy source. In addition, various membrane-based methods are known. Membrane-based methods include reverse osmosis in which salt water is forced under pressure through a membrane whose pores are of a size such that the salt is retained. Another method is electrodialysis in which two electrodes are immersed in an electrolyte solution. In the electric field of a DC-voltage, ion migration occurs in the salt water. By connecting cation and anion exchange membranes in an alternating series between the electrodes of an electrolysis cell, it is possible to direct the ion flow so that there is an increase in the concentration of electrolyte in the outer chambers while there is a decrease in concentration in the central chamber (i.e. a desalination effect occurs).

The membrane-based methods also include membrane distillation in which the water to be processed, which hereafter for the sake of simplicity is referred to as salt water, is held in a supply chamber whose wall is formed at least in part by a porous membrane having a hydrophobic surface that is generally referred to as a hydrophobic porous membrane. A hydrophobic surface is often defined as a surface that provides a water contact angle greater than 90 degrees, that is generally 100 to 120 degrees.

The pore size of the hydrophobic porous membrane, taking into account its hydrophobic properties (i.e. its surface tension with respect to water) must be such that the salt water does not fill the pores of the membrane, so the pores of the hydrophobic membrane contain air or another ambient gas. In other words, the maximum hydrostatic pressure, at which water will no longer pass through the hydrophobic porous membrane, also known as the bubble pressure, is lower than the pressure occurring in the supply chamber during operation of this desalination method.

In membrane distillation, salt water is evaporated through the hydrophobic porous membrane. The gaseous water condenses on the cooled distillate side of the membrane (i.e. the fresh water side). The distillation process for membrane distillation (as in conventional distillation processes) is based on the temperature difference between seawater which is heated and condensing fresh water which is cooled.

Membrane distillation can desalinate seawater using low grade thermal energy or solar heat, but it has limited mass flux resulting in low water flux and membrane fouling issues which impact both water flux and reliability of the process/system. Although flux enhancement for membrane distillation can be achieved by applying mechanical excitation, vacuum on the cold side of the membrane, or turbulence promoters inside fluid cells, these approaches require high-grade electrical energy, extra facility, or high pumping power. Accordingly, new membrane distillation structures and methods are needed that provide significantly enhanced water flux and reliability, without the need for high-grade electrical energy, extra facility, or high pumping power.

### SUMMARY

Disclosed embodiments include distillation membranes for purifying water that include a superhydrophobic surface comprising a plurality of protruding features that each include an inner microchannel therein that protrude from a recessed surface portion that is in a uniform thickness portion of the distillation membrane. As defined herein, a superhydrophobic surface is a surface that provides a water contact angle that is greater than 150 degrees at room temperature (25° C.).

A thickness of the uniform thickness portion defines a channel length of the distillation membrane. The distillation membrane includes a plurality of micropores that are each fluidicly coupled to respective ones of the microchannels, wherein the plurality of micropores extend through the entire channel length. The superhydrophobic surface is operable to reject liquid water and the microchannels coupled to the micropores are operable to pass water vapor therethrough which can be condensed on the side of the distillation membrane opposite to the superhydrophobic surface. Disclosed distillation membranes and methods disclosed herein significantly enhance water flux and reliability, without the need for high-grade electrical energy, extra facility, or high pumping power.

### BRIEF DESCRIPTION OF THE DRAWINGS

FIG. 1A is a cross sectional depiction of a superhydrophobic distillation membrane for purifying water during operation comprising a superhydrophobic surface comprising a plurality of protruding features shown as spikes having microchannels therein that protrude from a recessed surface portion of the distillation membrane, according to an embodiment of the invention.

FIG. 1B is a perspective representation of the superhydrophobic distillation membrane depicted in FIG. 1A.

FIG. 1C is a cross sectional depiction of a superhydrophobic distillation membrane including superhydrophobic surfaces comprising a plurality of protruding features shown as spikes having microchannels therein on both sides of the distillation membrane, according to another embodiment of the invention.

FIGS. 2A-F depict exemplary steps in a modified glass fiber drawing method according to an embodiment of the invention to produce glass distillation membranes with ordered pore sizes and nanospikes.

FIGS. 3A-F show scanned images and geometrical measures for nanospikes according to embodiments of the invention.

FIGS. 4A and B show scanned optical images of a 10 μL, water drop that sits on a superhydrophobic glass membrane with a cone angle of 20.4°, where the advancing and receding water contact angles are measured to be 165 and 159°, respectively, while FIGS. 4C and D show the temperature dependent mass change and the dependence of water flux on the membrane thickness at 95° C.

FIGS. 5A-C show results from various contact angle measures, according to embodiments of the invention.

### DETAILED DESCRIPTION

Disclosed embodiments in this Disclosure are described with reference to the attached figures, wherein like reference numerals are used throughout the figures to designate similar or equivalent elements. The figures are not drawn to scale and they are provided merely to illustrate the disclosed embodiments. Several aspects are described below with reference to example applications for illustration. It should be understood that numerous specific details, relationships, and methods are set forth to provide a full understanding of the disclosed embodiments. One having ordinary skill in the relevant art, however, will readily recognize that the subject matter disclosed herein can be practiced without one or more of the specific details or with other methods. In other instances, well-known structures or operations are not shown in detail to avoid obscuring structures or operations that are not well-known. This Disclosure is not limited by the illustrated ordering of acts or events, as some acts may occur in different orders and/or concurrently with other acts or events. Furthermore, not all illustrated acts or events are required to implement a methodology in accordance with this Disclosure.

Notwithstanding that the numerical ranges and parameters setting forth the broad scope of this Disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5.

Disclosed embodiments describe superhydrophobic membrane distillation membranes and related apparatus, membrane distillation methods, and methods for forming superhydrophobic membrane distillation membranes. Embodiments of the invention are based on the recognition by the Inventors that if a porous (e.g., microporous) membrane is made to be superhydrophobic, then the allowable pore sizes can be much larger than those of conventional membrane distillation membranes, thus allowing higher mass flux (i.e. more purified water output) without the need for high-grade electrical energy, extra facility, or high pumping power.

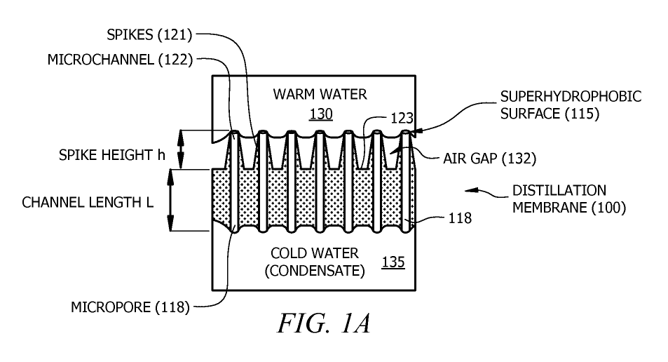

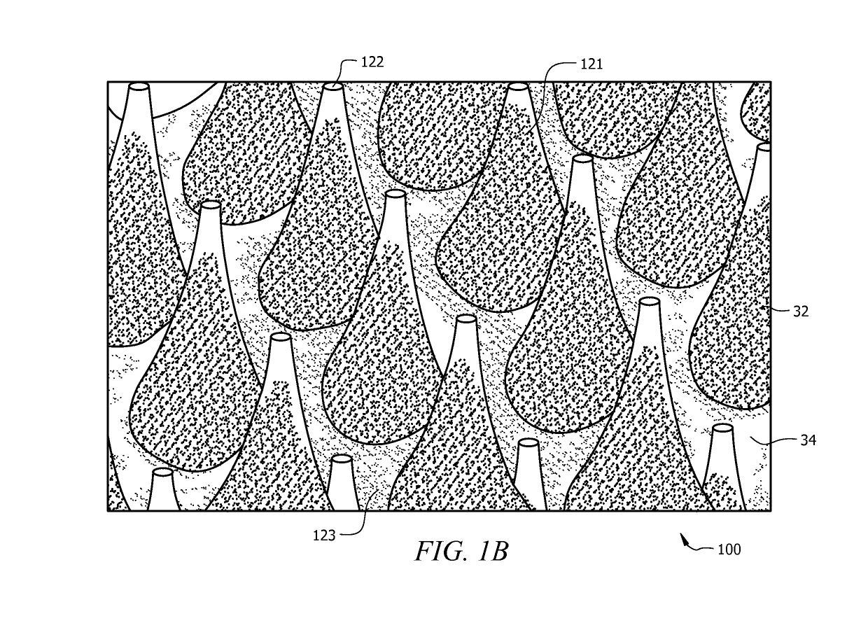

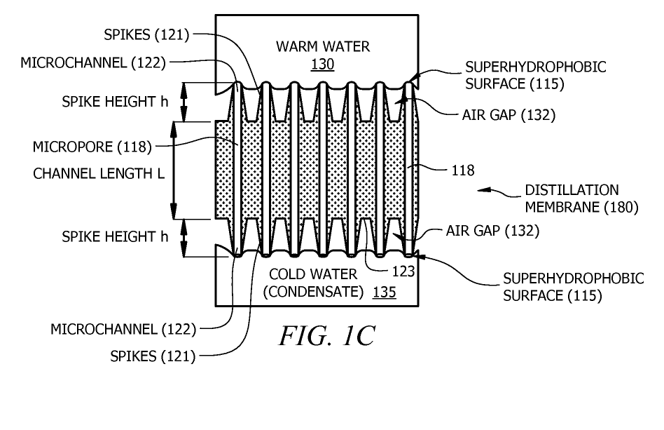

FIG. 1A shows a depiction of a superhydrophobic distillation membrane 100 for purifying water during operation including a superhydrophobic surface 115 comprising a plurality of protruding features shown as tapered “spikes” 121 having microchannels 122 therein, according to an embodiment of the invention. The spikes 121 protrude from a recessed surface portion 123 that is in a uniform thickness portion of the distillation membrane 100. A thickness of the uniform thickness portion 123 defines a channel length (L) of the distillation membrane. The distillation membrane 100 includes a plurality of micropores 118 that are each fluidicly coupled to respective ones of the microchannels 122, wherein the plurality of micropores 118 extend through the full channel length L. The superhydrophobic surface 115 is operable to reject liquid water and the microchannels 122 coupled to the micropores 118 are operable to pass water vapor therethrough from the warm water side to the cool water side to form cold and purified water (condensate) 135. FIG. 1B is a perspective representation of the superhydrophobic distillation membrane depicted in FIG. 1A.

The Inventors have recognized an advantage to operating distillation membrane 100 having the spiky side on the warm side of the distillation membrane 110 as shown in FIG. 1A. The spiky side of the distillation membrane 100 being the warm side generally enhances the water contact angle where it is helpful due to the generally decreasing water contact angle with increasing temperature described above, and thus prevents or at least reduces the leakage of hot (unpurified) water in liquid form from passing directly through distillation membrane 100 via the microchannels 122 then micropores 118.

The spikes 121 shown in FIG. 1A that provide a superhydrophobic surface 115 are in an ordered array having a spike height (h). The microchannels 122 are straight (i.e. linear; tortuosity factor=1) and are fluidly connected and aligned in a straight line (tortuosity factor=1) with the micropores 118 which are themselves straight (i.e. linear; tortuosity factor=1). The structure of the distillation membrane 100 shown in FIG. 1A wherein the microchannels 122 are straight and are fluidly connected and aligned in a straight line with the micropores 118 provides relatively low diffusion resistance, which can be contrasted with the structure of conventional distillation membranes. Such conventional distillation membranes have pore sizes that are hard to control and the path length for the vapor is elongated and thus the diffusion resistance high which reduces mass flux (i.e. less purified water output).

The pore size of micropores 118 is generally between 0.5 and 5 microns, such as 1 to 3 microns, and is enabled by the superhydrophobic surface 115 as described above. This pore size range is larger than conventional distillation membranes which allow higher mass flux (i.e. more purified water output).

The spike height (h) is generally from 0.5 to 100 microns. The spike height (h) sets the length of the air gaps 132 shown in FIG. 1A. The Inventors have recognized that if the height (h) of the spikes 121 is too short, the contact angle will generally be reduced which can lead to a small contact angle and as a result undesirable water leakage. The Inventors have also recognized if the height of the spikes 121 is too long, fabrication of the distillation membrane 100 generally takes significantly longer as compared to shorter spikes, and the spikes 121 may become fragile and thus subject to fracture. The channel length (L) of the distillation membrane 100 shown in FIG. 1 is generally from 50 to 5,000 microns (5 mm).

In one embodiment, the array of spikes 121 include at least one self-assembled monolayer of a fluorine-containing molecule thereon (not shown) to further increase the hydrophobicity of the superhydrophobic surface 115. For example, a fluorocarbon polymer can be used.

The distillation membrane 100 is generally formed from low thermal conductivity materials, defined herein as a 25° C. thermal conductivity <0.1 W/m·K. In one embodiment, the superhydrophobic distillation membrane 100 comprises a dielectric glass. In other embodiments of the invention, the distillation membrane 100 can comprise a porous metal or a ceramic. Other generally suitable material selections include most polymers, or air itself.

In one embodiment the superhydrophobic distillation membrane 100 comprises a glass membrane with spiky-ended microchannels 122 that are made through a process that involves glass fiber drawing, dissolving template material (salt) from microchannels, and differential glass etching. Superhydrophobic membranes with a water contact angle over 160° can be generated after surface modification due to the formation of an ordered array of sharp microstructures. Superhydrophobic distillation membranes disclosed herein have higher flux than those of existing polymer membrane especially at high salt concentration, owing to its larger pore size which as noted above is generally 0.5 to 5 microns, straight pore shape, narrow pore size distribution, high chemical and thermal stabilities, as well as good foul-resistance capability.

Although disclosed embodiments are generally described herein having a superhydrophobic surface on only one side of the distillation membrane, in other embodiments of the invention a superhydrophobic surface can be provided on both sides of the distillation membrane. FIG. 1C is a cross sectional depiction of a superhydrophobic distillation membrane for purifying water during operation comprising superhydrophobic surfaces comprising a plurality of protruding features shown as spikes having microchannels therein on both sides of the distillation membrane, according to another embodiment of the invention.

The Inventors have recognized that having both sides of the distillation membrane comprise superhydrophobic surfaces generally improves distillation membrane performance for both air gap (cold side) membrane distillation and direct contact membrane distillation (DCMD). As known in the art, DCMD refers to thermally driven transport of water through microporous hydrophobic membranes, where both sides of the membrane contact water, with one side contacting a hot solution (feed side) and the other side contacting a cold pure water (permeate side). Evaporation takes place at the hot feed side and, after water vapor is transported through the pores of the membrane, condensation takes place at the cold permeate side, inside the membrane.

The water contact angle is known to generally decreases as the temperature increases. Thus for a distillation membrane according to an embodiment of the invention having a superhydrophobic surface on both sides of the membrane (e.g., the same superhydrophobic surface), the cold side of the membrane will have larger contact angle as compared to the contact angle on the hot side.

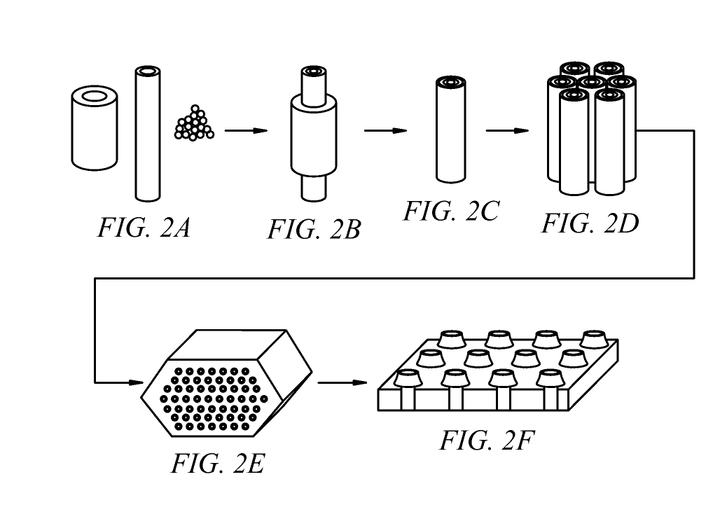

FIG. 2A-F depict a sequence of exemplary steps in a modified glass fiber drawing method according to an embodiment of the invention to produce glass distillation membranes with ordered pore sizes and nanospikes as disclosed herein. Preforms for fiber drawing can comprise commercial PYREX™ glass tubes of two compositions shown in FIG. 2A, which can be chosen in such a way that they have similar softening temperatures and coefficients of thermal expansion, but substantially dissimilar resistances to a selected chemical etchant. Salt powders (e.g., sodium chloride) are placed into a glass tube that can be etched slowly by the etchant (hard glass), and this tube is inserted into another glass tube that can be etched rapidly (soft glass) by the same etchant, with FIG. 2B showing the resulting intermediate structure. The soft glass can contain more borate oxide to thus react faster with a selected chemical etchant comprising hydrofluoric acid (HF) than the hard glass. The melting temperature of salt (801° C.) is close to the softening temperatures of the glasses (˜820° C.). The preforms are drawn into long microfibers (diameter of 400 μm) with the result depicted in FIG. 2C, which are cut into short pieces of equal length. Next, the short pieces are packed to form a parallel bundle shown in FIG. 2E that has an ordered hexagonal arrangement in the cross-sectional direction. The bundle is drawn again to form a long microfiber and is cut into short pieces, where the diameter and spacing of hard glass and the salt core are reduced from being on the order of millimeters to being on the order of micrometers (microns). The centimeter-long pieces from the second draw are subsequently assembled to form another bundle, which is annealed to form a glass rod and cut into thin plates with the result depicted in FIG. 2F. After the plates are polished using cloths of different grits, the thin plates are immersed in water (or other solvent) to dissolve the salt and are etched in HF to form the nanospiked microchannels.

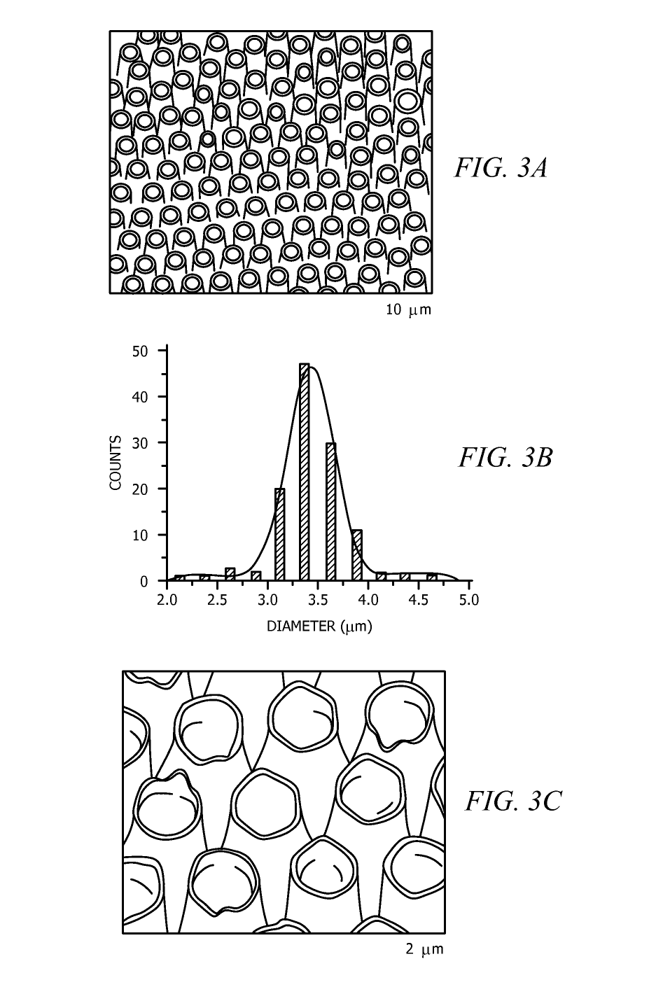

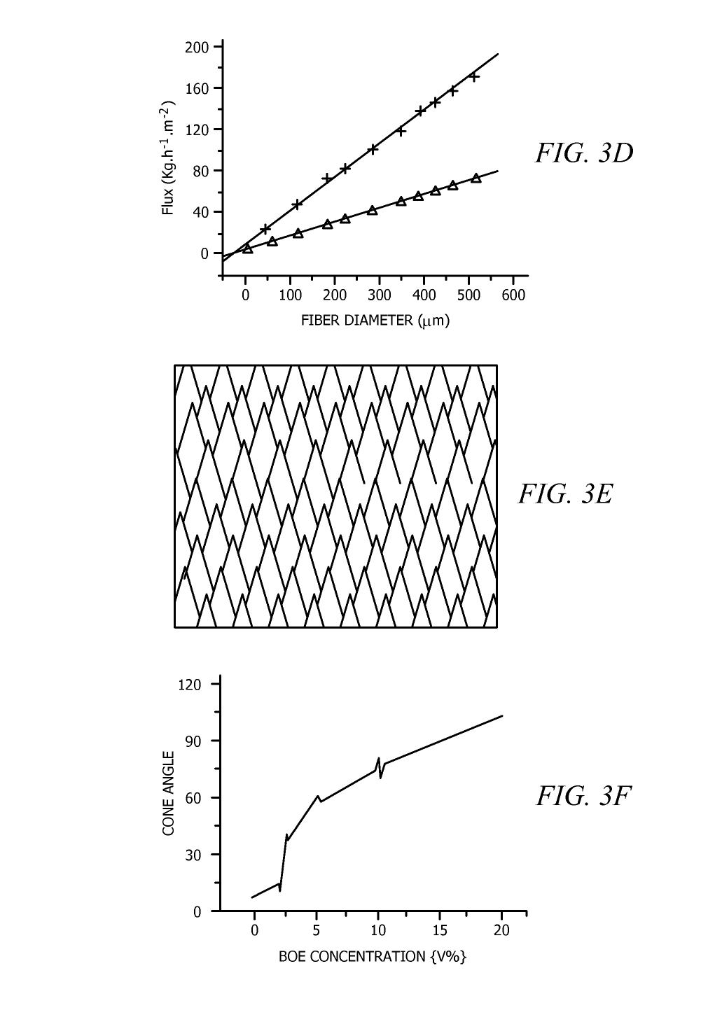

FIGS. 3A-F shows scanned images and geometrical measures for nanospikes according to embodiments of the invention. FIG. 3A shows a scanning electron microscopy (SEM) image of nanospiked microchannels made by etching a polished glass plate in a 1% v/v HF solution for 30 min at 25° C. The porosity derived from the surface area ratio of microchannels in the SEM image is about 26%. The pore diameter has a narrow distribution that is centered at 3.4 μm with 90% of the pore diameters falling in the range of 3 to 4 μm (FIG. 3B).

FIG. 3C shows a high-resolution mage taken at a 30° tilt angle, where the height, the bottomwidth, and the top width of a typical nanospike are measured to be 2.84 μm, 1.2 μm, and 170 nm, respectively, from which the cone angle of the nanospike at the cross section is determined to be 20.4°. The size reduction in the fiber drawing process has been studied by measuring the diameter and spacing of microchannels and the diameters of surrounding glass in the tapered piece left after each drawing cycle. The tapered pieces are sliced to thin plates of identical thickness. Each slide is then polished and etched slightly to develop nanospiked microchannels. As the diameters of surrounding glass decrease from 520 to 7 μm, the diameter 172 (square) and spacing (triangle) of the microchannel decrease linearly to 3.4 and 2 μm (FIG. 3D), respectively. The two lines in this FIG. have different slopes, from which the ratio of the coefficients of thermal expansion of glass to salt is derived to be 0.42. Taking the ratio into account, the diameter and spacing of microchannels after each draw can be derived using:

$${d}_{n} = \frac{{( {Φ}_{f} )}^{n} {β}^{n} R}{{[ 2 ( r + t ) ]}^{n - 1} ( R + T )}$$

$$and$$

$${l}_{n} = \frac{{( {Φ}_{f} )}^{n} T}{{[ 2 ( r + t ) ]}^{n - 1} ( R + T )}$$

where dₙ and lₙ are the diameter and spacing after n draws, respectively, Φ_{f} is the outer diameter of the microfiber, R and T are the inner radius and thickness of the glass tube used in the first draw, respectively, r and t are the inner radius and thickness of the glass tube used to bundle microfibers together, respectively, and β is the ratio of coefficients of the thermal expansion of glass materials and salt at the fiber drawing temperature (assuming two different glass materials have similar coefficients of thermal expansion). This method has good control over the diameter and spacing of microchannels: the diameter and spacing obtained from the equation above are 3.1 and 1.8 μm, and the actual diameter and spacing measured from the images are 3.4 and 2.0 μm, respectively. Furthermore, the sharpness (i.e. cone angle) of the nanospike can be controlled by changing the etching conditions.

The Inventors have fabricated cone-shaped nano spikes by using the same method, where the preform is formed by inserting a rod of hard glass into a tube of soft glass. The preform is drawn into long microfibers, which are cut into short, even pieces, and bundled together for the next draw cycle. After the second draw, the short pieces are bundled and annealed into a rod. The rod is then cut into plates, followed by polishing the plates using different grits.

FIG. 3E shows an array of nanospikes etched in a mixed etchant containing 4% HF and 2.5% BOE for 60 min. Depending on the etching conditions (i.e. time and concentration), the cone angles can be adjusted to between 5 to 110° (FIG. 3F). Although the etching conditions to make nanospiked microchannels are different from those to make cone-shaped nanospikes (in order to avoid the over-etching of the inner surfaces of microchannels), adding a buffer to the etchant to provide BOE adjusts the etching rate by providing a nearly constant concentration of fluoride ions and has been used to make nanospiked microchannels.

As disclosed above, too generate or increase superhydrophobicity, glass membranes with nanospiked microchannel arrays can be modified with self-assembled monolayers, such as fluorine-containing molecules, typically fluorocarbon polymers, for example by immersing the etched glass plate in 1% solutions of tridecafluoro-1,1,2,2-tetra-hydrooctyl-trichlorosilane in hexane for 30 mins. The sample is dried, held at 120° C. for 10 mins., and rinsed in isopropanol to remove extra molecules. The modified resulting coated membrane repels water drops strongly.

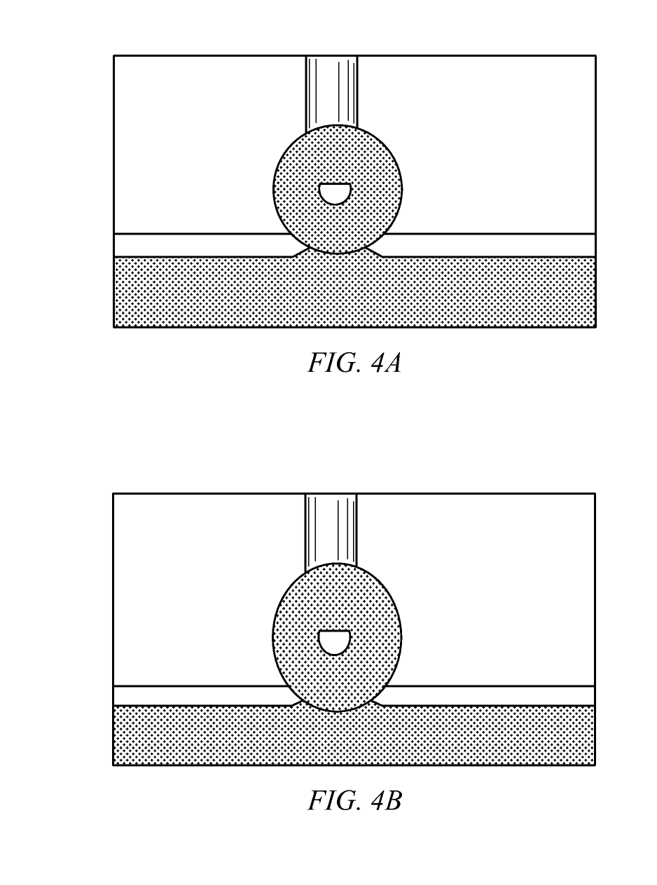

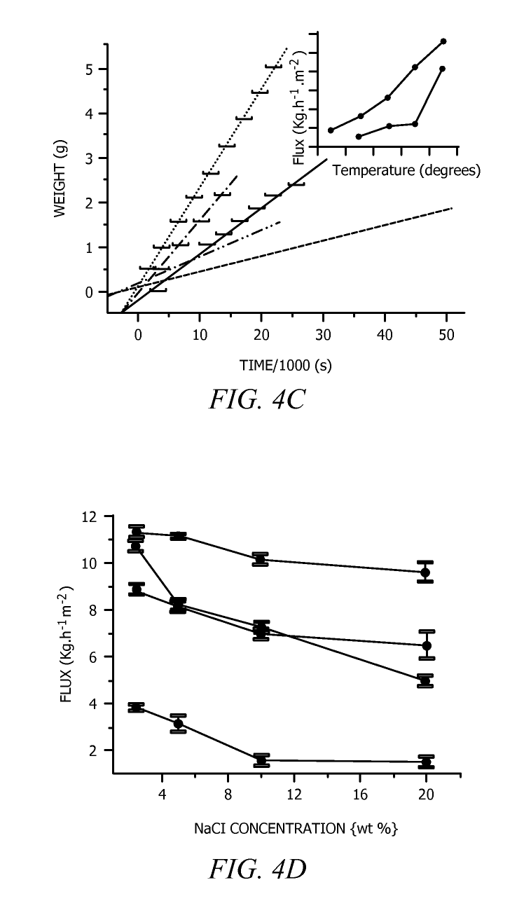

FIGS. 4A and B show the optical images of a 10 μL water drop that sits on a superhydrophobic glass membrane with a cone angle of 20.4°, where the advancing and receding water contact angles are measured to be 165 and 159°, respectively. In comparison, a 10 μL drop of hexane can pass through the membrane rapidly, thus confirming the permeability of the membrane. For nanospiked microchannel arrays fabricated in the same drawing process (i.e. they have the same diameter and spacing), water contact angles depend on the cone angle of spiked nanostructures. The Inventors have etched several thin glass polished plates in mixed etchants that contain 1% HF and different amounts of BOE. By keeping the same etching time (30 mins.), the cone angles of spiked nanostructures are controlled at 20.4°, 45.4°, and 87.4° by changing BOE concentrations at 0%, 5%, and 10%, respectively. After surface modification with the fluorine monolayer, the glass membranes were found to have water contact angles of 165°, 146°, and 135°, respectively. This trend in contact angle change is consistent with the previous observations: the water contact angle depends on the sharpness (cone angle) of the nanospikes, provided that the diameter, spacing, and area density of the nanospikes are the same.

Applications for embodiments of the invention include producing fresh water (clear water) from salt water (especially seawater or brackish water) as generally described above. However, disclosed embodiments are also suitable for other applications in which the object is to obtain purified water by distillation from contaminated water. This includes purification of water contaminated with bacteria or viruses (e.g., wastewater or river water).

Although generally described herein being applied to air gap membrane distillation, embodiments of the invention are generally applicable to all membrane distillation processes and systems, including direct contact membrane distillation, sweeping gas membrane distillation, and vacuum membrane distillation. Moreover, although the superhydrophobic surfaces are described herein as being based on a plurality of glass comprising spikes, embodiments of the invention may be based on superhydrophobic surfaces having other feature shapes and/or a variety of other materials.

### Examples

Embodiments of the invention are further illustrated by the following specific Examples, which should not be construed as limiting the scope or content of embodiments of the invention in any way.

To evaluate the performances of superhydrophobic distillation membranes in water desalination, an air gap membrane distillation system is established where one side of a membrane is in contact with the hot feedwater and the other side is exposed to air at ambient conditions (i.e. 22° C. and 1 atm). The masses and the conductivities of permeate water are measured continuously by an electronic balance and a conductivity meter, respectively. An electrical heating tape is used to heat the feedwater that contains a certain amount of salt in deionized water. The temperature at the interface of the membrane and feedwater is monitored by an electric thermometer that is inserted close to the membrane from the feedwater side. The operating pressures are maintained at 1,700 Pa, and the feedwater is kept stationary.

FIG. 4C shows the temperature-dependent mass changes of the permeate water through a superhydrophobic glass membrane that has a pore diameter of 3.4 μm, an interpore spacing of 2 μm, a porosity of 26%, a membrane thickness of 500 μm, and a water contact 255 angle of 165°. The stepwise mass change is induced by the intermittent outflow of condensed water. The mass fluxes at 55, 65, 75, 85, and 95° C. for 5% salt concentration were determined to be 1.8, 3.3, 5.12, 8.4, and 11.1 kg/m² per hour from the slopes of lines and the membrane areas after compensating evaporation loses (see squares in FIG. 4C inset). As the feedwater temperature increases, the flux increases because it has a high vapor pressure. FIG. 4D indicates the thickness and salt-concentration-dependent mass fluxes at a temperature of 95° C., where the diamonds, triangles, and circles represent the mass fluxes of membranes with thicknesses of 1,200, 800, and 500 μm, respectively.

Briefly, a thinner membrane has a higher flux because of the small diffusion resistance for vapor, and the flux decreases as the salt concentration increases as a result of the low vapor pressure of the feedwater. Furthermore, the Inventors we have measured the mass fluxes of a commercial microporous polypropylene membrane obtained from Chemplex (catalog no. 325), which has an average pore diameter of 220 nm, a porosity of 55%, a thickness of 25 μm, and a contact angle of 115°. Although the squares in FIG. 4D show that the polymer membrane has similar mass flux values to the 500-μm-thick superhydrophobic membrane according to an embodiment of the invention at a temperature of 95° C. for the feedwater containing 2.5% salt, the mass fluxes of the polymer membrane decrease to 8.24, 7.28, and 5.03 kg/m² per hour at salt concentrations of 5, 10, and 20%, respectively. In contrast, the mass flux of the 500-μm-thick superhydrophobic membrane according to an embodiment of the invention is nearly constant (changing from 11.3 to 9.63 kg/m² per hour) when the salt concentration is increased from 2.5 to 20%. In the temperature range between 55 and 95° C., the polymer membrane has a lower flux than the 500 μm superhydrophobic glass membrane for 5% salt solution as indicated in the FIG. 4C inset. If glass membranes could be made thinner by fine polishing or reactive etching prior to chemical etching or more porous by using starting glass tubes of various geometries, then the mass fluxes would be even higher.

The Inventors have studied the effect of the water contact angle on the mass flux and salt rejection of glass membranes, both of which are related to the liquid entry pressure of water (LEPW) (i.e. the minimal pressure at which liquid water and salt will overcome surface tension and enter hydrophobic pores). LEPW depends on the diameter and spacing of spiked nanostructures, the water contact angle, the surface tension, and the temperature of the feedwater. For simplicity, the Inventors have derived the relationship between the LEPW and the structure of cone-shaped nanospikes.

The LEPW of an ordered array of cone-shaped nanospikes could be derived from the geometries and area densities of nanospikes. Assuming that a circular water-solid-vapor contact line was formed around each nanospike, the LEPW of the nanospike array can be derived by maximizing the surface tension pressure (P) using the following equation:

LEPW=Pᵥₘₓ=2σ\sqrt{πpα sin φ}sin(θ−90°−φ) (2)

where F is the area density of a nanospike with units of number/μm2, R is the fraction of wetted area on each nanospike relative to the total projected area, σ is the surface tension of the feedwater, θ is the contact angle of a flat glass after surface modification (112.4°), and φ is the half-cone angle of a nanospike. R can be changed from nearly 0% (Cassie state) to 100% (Wentzel state) as water is gradually pushed into the array of nanospikes.

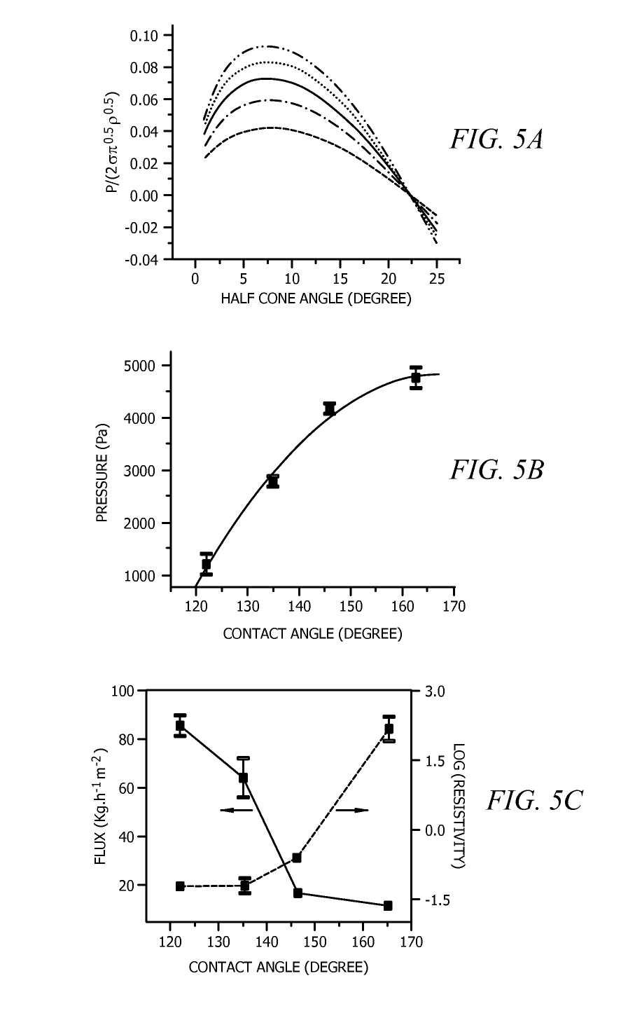

FIG. 5A shows the simulated relationships between the LEPWs, the half-cone angles of a nanospike, and the fraction of wetted areas. The LEPW increases until the half-cone angle reaches 7.5° which can also be derived from φ≈(θ−90°)/3 as the first-order solution to the LEPW equation. The Inventors have measured the LEPWs of several glass membranes that have identical pore geometries (i.e. diameter and spacing) but different cone angles and water contact angles. The LEPWs are measured by applying increasing hydraulic pressure to each membrane and monitoring the appearance of water drop on the other side of the membrane. FIG. 5B indicates the LEPW of each membrane as a function of the water contact angle, where the membrane with a larger water contact angle supports a higher pressure. For the membrane with a water contact angle of 165°, the effective area density of the spiked nanostructures is derived as 0.044/μm² from the equation using an LEPW of 4760 Pa, φ of 10.2°, R of 100%, and σ of 0.072 N/m. Because this effective area density is larger than the number density of ring-shaped, nanospiked microchannels counted from the corresponding SEM image (0.031/μm²), the Inventors concluded that one spiked nanostructure is equivalent to 1.42 normal cone-shaped nanospikes for the enhancement of membrane hydrophobicity.

Furthermore, the Inventors have measured the mass flux and salt rejection ability of membranes with water contact angles of 122, 135, 146, and 165°, where the salt rejection is evaluated by measuring the resistivity of permeate water. FIG. 5C shows an opposite trend between the mass flux and salt rejection of these glass membranes (pore diameter of 3.4 μm, interpore spacing of 2 μm, and thickness of 500 μm) at a temperature of 95° and an operating pressure of 1700 Pa. A membrane with a small contact angle has a large mass flux, but the permeate water contains more salt as a result of pore wetting. Although the mass flux of a flat glass membrane is greater than 80 kg/m² per hour, this membrane will leak at the same operating pressure and temperature because of its small water contact angle (122°). In addition, although the LEPWs of two membranes (water contact angles of 135 and 146° measured at 22° C.) are higher than the operating pressure, the surface tension of water and the water contact angle decrease at high temperature, which causes low allowable pressure and poor salt rejection. For the superhydrophobic glass membrane (water contact angle of 165°), the passage of salt through the micropores is completely blocked, and the mass flux is about 10 kg/m² per hour.

The superhydrophobic glass membranes have shown much better fouling-resistance abilities than polymer membranes in an accelerated fouling evaluation process. The Inventors have observed the morphologies of the superhydrophobic glass membrane with a contact angle of 165° and the commercial polypropylene membrane with a contact angle of 115° after 15 hrs. of desalination at 95° C. in a 10% salt solution contained in a steel tube. In membrane distillation processes according to embodiments of the invention, the mean free path of a water vapor molecule is shorter than the pore diameter (˜3 μm), thus the mass flux is controlled by molecular diffusion as:

$$J = \frac{1 {r}^{2} ɛ 1 Mp}{8 {χ}^{δ} η RT} Δ p = \frac{1 {r}^{2} ɛ}{8 {χ}^{δ}} K \qquad ( 3 )$$

where r is the pore radius, χ is the tortuosity factor of pores, δ and ∈ are the thickness and porosity of the membrane, M is the molecular weight, p is the vapor pressure in the pores, Δp is the vapor pressure difference across the membrane, and η is the viscosity of the vapor. Assuming the same K at operating conditions, the flux across a glass membrane according to an embodiment of the invention (with a pore radius of 1.7 μm, thickness of 500 μm, tortuosity factor of 1, and porosity of 26%) can be much higher than that across a polymer membrane (average pore radius of 110 nm, thickness of 25 μm, tortuosity factor of 2, and porosity of 55%). In the experiment performed, the mass flux of a superhydrophobic glass membrane according to an embodiment of the invention was found to be 2 times that of a hydrophobic polymer membrane at a salt concentration of 20% (FIG. 4D). If the glass membrane could be made thinner or more porous, then the mass flux would be enhanced more. From a heat conduction perspective, an air gap is formed between the feedwater and the nanospiked superhydrophobic membrane. The equivalent thermal conductivity (k_{eq}) of the membrane can be determined by the volume fraction of air or vapor and membrane material using the following equation:

$${k}_{eq} = {k}_{air} \frac{{v}_{air}}{V} + {k}_{spike} \frac{{v}_{spike}}{V} \qquad ( 4 )$$

where kₐᵢᵣ and kₛₚᵢₖₑ are the thermal conductivities of air and the membrane material, vₐᵢᵣ and vₛₚᵢₖₑ are the volumes of the air gap and spiked nanostructure, respectively, and V is the total volume of the air gap and spiked structure. In air gap membrane distillation, one side of the membrane is in contact with water, and the other side is in contact with air. The Inventors have calculated the thermal conductivity of a superhydrophobic glass or polymer membrane with a pore diameter (b) of 4 μm, a nanospike height (m) of 10 μm, an interpore spacing (a) of 5.35 μm, and a cone angle (θ) of 30° (FIG. 2), where the thermal conductivities of glass, polymer, and air are taken to be 1.1, 0.16, and 0.025 W/m·K, respectively.

In Table 1, the thermal conductivities of flat glass and a polymer membrane with the same features and thickness are also listed for comparison, where the pore size (b) is 4 μm and the spacing (a) is 5.35 μm.

TABLE 1
Calculated Thermal Conductivities of Nanospiked Membranes.
(W · m⁻¹ · K⁻¹)

| thickness | 500 μm | 200 μm | 25 μm |
|---|---|---|---|
| glass membrane with spiked | 0.66 | 0.6485 | 0.498 |
| nanostructures | | | |
| glass membrane without spiked | 0.67 | 0.67 | 0.67 |
| nanostructures | | | |
| relative change | 1.5% | 3.2% | 25.7% |
| polymer membrane with spiked | 0.10492 | 0.1033 | 0.0844 |
| nanostructures | | | |
| polymer membrane without spiked | 0.106 | 0.106 | 0.106 |
| nanostructures | | | |

Because the thermal conductivity of air is lower than those of glass and polymer, replacing part of the membrane materials with either air or vapor could reduce the heat conduction through membrane, which will enhance vapor generation at the operating temperature. As the membrane becomes thinner, the fraction of thermal conductivity reduction due to this material replacement is increased. Furthermore, making nanospike-based superhydrophobic polymer membranes according to embodiments of the invention can reduce heat conduction more than those of superhydrophobic glass ones with the same structure because of the relative low thermal conductivities of polymers, but polymer membranes have low thermal and chemical stabilities and thus short lifetimes in hot corrosive feedwater. Moreover, for either a glass or polymer membrane, incorporating superhydrophobic spiked nanostructures according to embodiments of the invention can mitigate fouling issues by reducing water-membrane contact areas.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

Thus, the breadth and scope of the subject matter provided in this Disclosure should not be limited by any of the above explicitly described embodiments. Rather, the scope of this Disclosure should be defined in accordance with the following claims and their equivalents.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which embodiments of the invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

We claim:

1. A distillation membrane for purifying water, comprising:
a superhydrophobic surface comprising a plurality of protruding features that each include a microchannel therein that protrude from a recessed surface portion that is in a uniform thickness portion of said distillation membrane, wherein a thickness of said uniform thickness portion defines a channel length of said distillation membrane;
wherein said distillation membrane comprises a plurality of micropores that are each fluidicly coupled to respective ones of said microchannels, and wherein said plurality of micropores extend through said channel length, and
wherein said superhydrophobic surface is operable to reject liquid water and said microchannels coupled to said plurality of micropores are operable to pass water vapor therethrough.

2. The distillation membrane of claim 1, wherein said plurality of protruding features comprise an ordered array of spikes.

3. The distillation membrane of claim 2, wherein said array of spikes include at least one self-assembled monolayer of a fluorine-containing molecule thereon.

4. The distillation membrane of claim 1, wherein said protruding features comprise a first composition and said recessed surface portion comprises a second composition different from said first composition.

5. The distillation membrane of claim 4, wherein said first composition and said second composition both comprises glasses, wherein an etch rate of said second composition is higher in an oxide etch as compared to an etch rate of said first composition in said oxide etch.

6. The distillation membrane of claim 1, wherein said microchannels are straight, said plurality of micropores are straight, and respective ones of said microchannels and respective ones of said plurality of micropores are aligned to one another.

7. The distillation membrane of claim 1, wherein a pore size of said plurality of micropores is between 0.5 and 5 microns.

8. The distillation membrane of claim 1, wherein a height of said plurality of protruding features is from 0.5 to 100 microns.

9. The distillation membrane of claim 1, wherein said channel length is from 50 to 5,000 microns.

10. The distillation membrane of claim 1, wherein said distillation membrane comprises glass, polymer, or a ceramic.

11. The distillation membrane of claim 1, further comprising a second plurality of protruding features on a side of said superhydrophobic distillation membrane opposite to said plurality of protruding features.

12. A membrane distillation method for purifying water, comprising:
providing a distillation membrane having a superhydrophobic surface comprising a plurality of protruding features that protrude from a recessed surface portion that is in a uniform thickness portion of said distillation membrane, said plurality of protruding features each including inner microchannels that are fluidicly coupled to micropores that extend to a side of said distillation membrane opposite superhydrophobic surface;
contacting said superhydrophobic surface with water to be purified, wherein said said superhydrophobic surface is operable to reject liquid water and said microchannels coupled to said plurality of micropores are operable to pass water vapor therethrough to said side of said distillation membrane opposite superhydrophobic surface, and
condensing said water vapor to generate purified water.

13. The method of claim 12, wherein said plurality of protruding features comprise an ordered array of spikes.

14. The method of claim 13, wherein said array of spikes include at least one self-assembled monolayer of a fluorine-containing molecule thereon.

15. The method of claim 12, wherein a pore size of said plurality of micropores is between 0.5 and 5 microns.

16. The method of claim 12, wherein said microchannels are straight, said plurality of micropores are straight, and respective ones of said microchannels and respective ones of said plurality of micropores are aligned to one another.
